(19) United States
(12) Patent Application Publication
(10) Pub. No.: US 2014/0054987 A1
(43) Pub. Date: Feb. 27, 2014

(54) ROTATING ELECTRICAL MACHINE

(71) Applicants: Tomohiko MIYAMOTO, Nagakute-shi (JP); Satoshi MURAKAMI, Nishio-shi (JP)

(72) Inventors: Tomohiko MIYAMOTO, Nagakute-shi (JP); Satoshi MURAKAMI, Nishio-shi (JP)

(73) Assignees: AISIN AW CO., LTD., Anjo-shi (JP); TOYOTA JIDOSHA KABUSHIKI KAISHA, Toyota-shi (JP)

(21) Appl. No.: 13/964,625

(22) Filed: Aug. 12, 2013

(30) Foreign Application Priority Data
Aug. 27, 2012 (JP) 2012-186758

(51) Int. Cl. H02K 9/19

(52) U.S. Cl. CPC H02K 9/19
USPC 310/54

(57) ABSTRACT

A rotating electrical machine includes: a rotor equipped with a first coolant flow channel therein; an end plate arranged at an end of the rotor in an axial direction of the rotating electrical machine, the end plate being equipped with a second coolant flow channel that communicates with the first coolant flow channel and a coolant discharge hole, the coolant discharge hole being provided on a radially inner side with respect to a position of communication with the first coolant flow channel, the coolant discharge hole being configured to discharge a certain amount or more of coolant to an outside of the rotor; and a rotor shaft equipped with a third coolant flow channel that communicates with the second coolant flow channel.

### INCORPORATION BY REFERENCE

The disclosure of Japanese Patent Application No. 2012-186758 filed on Aug. 27, 2012 including the specification, drawings and abstract is incorporated herein by reference in its entirety.

### BACKGROUND OF THE INVENTION

1. Field of the Invention

The invention relates to a rotating electrical machine, and more particularly, to a cooling structure for a rotating electrical machine.

2. Description of Related Art

Conventionally, there has been proposed a structure in which a coolant flow channel is formed inside a rotor shaft of a rotating electrical machine and coolant is supplied from the coolant flow channel into a rotor through the use of a rotating centrifugal force to thereby cool the rotor. Owing to this structure, laminated steel sheets and permanent magnets that constitute the rotor of the rotating electrical machine are cooled.

Japanese Patent Application Publication No. 2012-16240 (JP-2012-16240 A) discloses a configuration in which a shaft-side coolant flow channel through which oil flows is formed inside a rotor shaft, and a coolant flow channel that communicates with the shaft-side coolant flow channel is provided between a rotor core and an end plate.

Coolant such as oil or the like that has been supplied to the coolant flow channel inside the rotor shaft is supplied into the rotor through the use of a rotating centrifugal force of the rotor. During high-speed rotation of the rotor with a relatively large rotating centrifugal force, coolant is supplied into the rotor. On the other hand, during low-speed rotation of the rotor with a relatively small rotating centrifugal force, a sufficient amount of coolant may not be supplied into the rotor due to a resistance of the coolant flow channel. In this case, there is an apprehension that the amount of coolant may become excessive in the rotor shaft, and that the excessive amount of coolant may flow into another member side, for example, a planetary gear side instead of flowing in a direction into the rotor and thus may cause an increase in dragging loss.

FIG. 4 shows an example of a structure for cooling a rotor by supplying coolant from a coolant flow channel of a rotor shaft into a rotor. Incidentally, for convenience of explanation, only an essential part is shown with a case, a stator and the like of a rotating electrical machine omitted.

In FIG. 4, an oil pool 24 is formed in the rotor shaft of the rotating electrical machine, and oil is stored therein as coolant. A rotor 16 is fixed to the rotor shaft. An end plate 20 is formed at an end of the rotor 16. A coolant flow channel 28 is formed in the rotor 16 in an axial direction. One end of the coolant flow channel 28 reaches a permanent magnet 18 in the rotor 16. Besides, a coolant flow channel 30 is formed in the end plate 20 in a radial direction. One end of the coolant flow channel 30 communicates with the coolant flow channel 28. The other end of the coolant flow channel 30 communicates with the oil pool 24 via an in-rotor-shaft coolant flow channel 26.

If a rotating centrifugal force is applied in the configuration as described above, coolant flows from the oil pool to the coolant flow channel 26, and further to the coolant flow channel 30 and the coolant flow channel 28 to cool the rotor 16 and the permanent magnet 18.

However, during low-speed rotation of the rotor, the rotating centrifugal force is also small, so that coolant cannot smoothly flow through the aforementioned route. In particular, coolant does not smoothly flow due to a conduit resistance in the coolant flow channel 28 in the axial direction, so that a drop in cooling efficiency is caused. Besides, if coolant does not smoothly flow, an excessive amount of coolant remains in the oil pool 24. The excessive amount of coolant that remains in the oil pool 24 overflows from the rotor shaft, and flows into a planetary gear or the like. Thus, the amount of oil in the planetary gear becomes excessively large, and an increase in dragging loss is caused.

### SUMMARY OF THE INVENTION

The invention sufficiently cools a rotor regardless of the rotational speed of a rotor shaft. Besides, the invention suppresses the occurrence of a situation in which the amount of coolant in the rotor shaft becomes excessive especially during low-speed rotation of the rotor shaft, and suppresses an increase in dragging loss.

A rotating electrical machine according to an aspect of the invention includes a rotor, an end plate, and a rotor shaft. The rotor is equipped with a first coolant flow channel therein. The end plate is arranged at an end of the rotor in an axial direction of the rotating electrical machine, and is equipped with a second coolant flow channel that communicates with the first coolant flow channel, and a coolant discharge hole. The coolant discharge hole is provided on a radially inner side with respect to a position of communication with the first coolant flow channel, and is configured to discharge a certain amount or more of coolant to an outside of the rotor. The rotor shaft is equipped with a third coolant flow channel that communicates with the second coolant flow channel.

In the aspect of the invention, coolant such as oil or the like flows from the rotor shaft to the first coolant flow channel via the second coolant flow channel, and is supplied into the rotor to cool the rotor. If the rotating centrifugal force is relatively small during low-speed rotation of the rotor shaft and coolant becomes unlikely to flow due to a resistance of the first coolant flow channel, coolant is accumulated in the second coolant flow channel. However, if a certain amount or more of coolant is accumulated, coolant is discharged from the coolant discharge hole. Therefore, the amount of coolant in the rotor shaft is restrained from becoming excessive. Besides, a surplus of coolant that has been discharged to the outside of the rotor can also be utilized to cool the outside of the rotor, especially the end of the rotor. Therefore, the rotor is efficiently cooled.

In an embodiment of the invention, the coolant discharge hole may not discharge coolant in the second coolant flow channel if a rotational speed of the rotor shaft is equal to or higher than a threshold rotational speed, and may discharge a certain amount or more of coolant in the second coolant flow channel if the rotational speed of the rotor shaft is lower than the threshold rotational speed.

During high-speed rotation with the rotational speed of the rotor shaft being equal to or higher than the threshold rotational speed, coolant flows from the rotor shaft to the first coolant flow channel via the second coolant flow channel, and is supplied into the rotor to cool the rotor. During low-speed rotation with the rotational speed of the rotor shaft being lower than the threshold rotational speed, a surplus amount of coolant exceeding the certain amount is discharged to the outside of the rotor from the second coolant flow channel as well as from the aforementioned flow channel.

According to the aspect of the invention, the rotor can be sufficiently cooled regardless of the rotational speed of the rotor shaft. Besides, according to the aspect of the invention, the occurrence of a situation in which the amount of coolant becomes excessive in the rotor shaft especially during low-speed rotation of the rotor shaft can be suppressed, and an increase in dragging loss can be suppressed.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is a schematic cross-sectional view of a rotating electrical machine according to the embodiment of the invention;

FIG. 2 is an illustrative view of the operation during high-speed rotation according to the embodiment of the invention;

FIG. 3 is an illustrative view of the operation during low-speed rotation according to the embodiment of the invention; and

FIG. 4 is a schematic cross-sectional view of a conventional rotating electrical machine.

### DETAILED DESCRIPTION OF EMBODIMENT

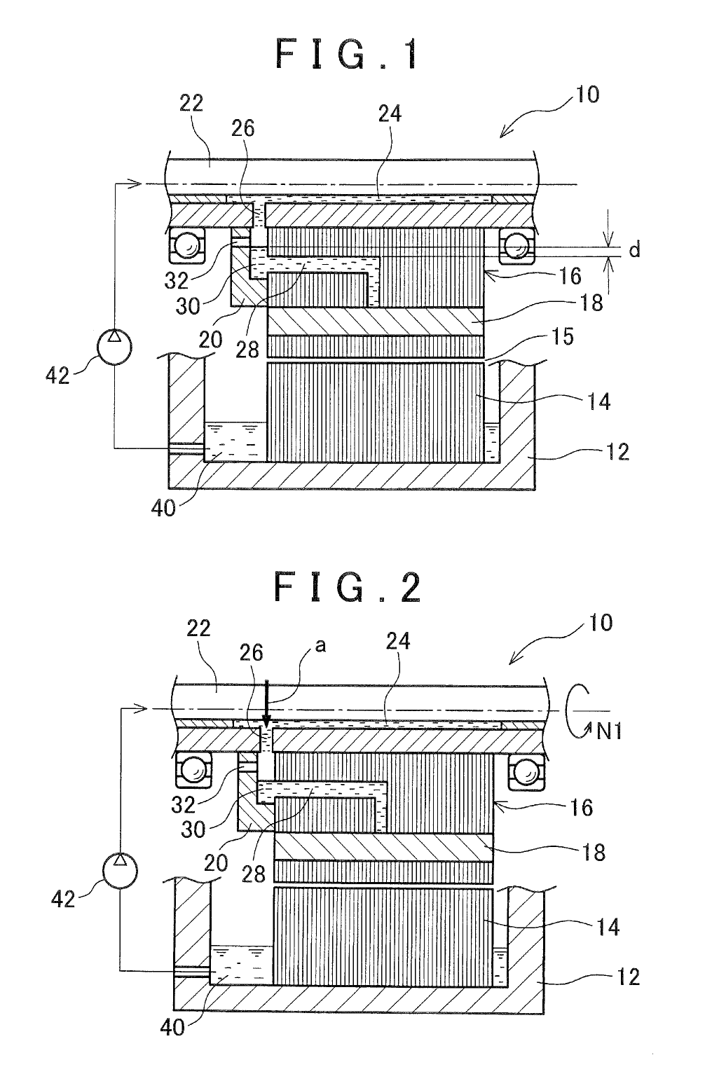

The embodiment of the invention will be described hereinafter on the basis of the drawings. However, the following embodiment of the invention is merely an exemplification. The invention should not be limited to the following embodiment thereof.

[symbol] Basic Configuration of Rotating Electrical Machine [symbol] First of all, the basic configuration of a rotating electrical machine according to this embodiment of the invention will be described. FIG. 1 is a schematic cross-sectional view showing the rotating electrical machine. The rotating electrical machine can be used as a motor that drives a hybrid vehicle or an electric vehicle, or as a generator for generating electricity.

In FIG. 1, a rotating electrical machine 10 is equipped with a motor case 12 as a housing, a stator 14 that is fixed to an inner face of the motor case 12, a rotor 16 that is arranged opposite the stator 14 on a radially inner side thereof, and a rotor shaft 22 that fixes the rotor 16.

The stator 14 includes a stator core that is constituted by laminating a plurality of magnetic steel sheets on one another in an axial direction, and a stator coil that is wound around teeth provided on an inner peripheral face of the stator core at a plurality of locations in a circumferential direction thereof. The stator core is fixed to an inner face of the motor case 12.

The rotor 16 is fixed to a radially outer side of the rotor shaft 22, and is arranged opposite the radially inner side of the stator 14 via an air gap 15. The rotor 16 includes a rotor core, permanent magnets 18, and an end plate 20. The rotor core has a laminated body that is constituted by laminating the plurality of the magnetic steel sheets on one another in the axial direction. The permanent magnets 18 are arranged on the rotor core at a plurality of locations in a circumferential direction thereof. The permanent magnets 18 are magnetized in a radial direction of the rotor 16 or in a direction inclined with respect to the radial direction.

The rotor 16 is fixed to the rotor shaft 22. The rotor shaft 22 is rotatably and pivotally supported by a bearing of the motor case 12. A coolant flow channel through which oil as coolant flows, and an oil pool 24 that communicates with this coolant flow channel are formed in the rotor shaft 22. Oil as coolant functions not only as coolant for cooling the rotor 16 but also as lubricating oil at the same time. It is possible to adopt a configuration in which the coolant flow channel in the rotor shaft 22 is formed on an axis of rotation of the rotor shaft 22, and coolant is supplied from this coolant flow channel to the oil pool via a plurality of locations. However, the shapes of the coolant flow channel and the oil pool 24 may be arbitrary without being limited in particular. Incidentally, in Japanese Patent Application Publication No. 2006-67777 (JP-2006-67777 A), a coolant flow channel that is formed on a central axis in a rotor shaft, and a coolant flow channel that radially extends from this coolant flow channel are disclosed. Such a configuration can also be encompassed by the invention.

The motor case 12 accommodates the stator 14 and the rotor 16, and has, inside a lower portion thereof, an in-case oil pool portion 40 in which oil as coolant is accumulated. Oil in the in-case oil pool portion 40 is pumped up by an oil pump 42, and is supplied to the rotor shaft 22.

[symbol] Configuration of Coolant Flow Channel [symbol] Next, the coolant flow channel of the rotating electrical machine 10 according to this embodiment of the invention will be described.

In FIG. 1, a coolant flow channel 28 is formed in the rotor 16 toward the inside of the rotor core in the axial direction. One end of the coolant flow channel 28 reaches the permanent magnets 18 in the rotor 16. That is, the coolant flow channel 28 in the axial direction extends in the axial direction to the inside of the rotor core from an end of the rotor 16 that abuts on the end plate 20, and is flexed toward the permanent magnets 18 at a substantially central portion of the rotor 16 in the axial direction thereof, and the end of the flexed channel reaches the permanent magnets 18.

A coolant flow channel 30 is formed in the end plate 20 in a radial direction of the rotor 16, and one end of the coolant flow channel 30 communicates with the coolant flow channel 28. That is, the coolant flow channel 30 is formed in the end plate 20 in the radial direction, and this coolant flow channel 30 and the coolant flow channel 28 communicate with each other on an abutment face of the end plate 20 and the rotor 16. The coolant flow channel 30 can also be regarded as a radial groove of the end plate 20 that is formed on the abutment face side on the rotor 16. Besides, the coolant flow channel 30 can also be expressed as an in-end-plate oil pool portion for supplying oil from the oil pool 24 to the coolant flow channel 28 in the axial direction. Alternatively, the coolant flow channel 28 in the axial direction is a flow channel for cooling the inside of the rotor core. Therefore, the coolant flow channel 30 that communicates with the coolant flow channel 28 can be expressed as an in-end-plate oil pool portion for supplying oil into the rotor core.

In the rotor shaft 22, a coolant flow channel 26 is formed in the radial direction of the rotor 16. One end of the coolant flow channel 26 communicates with the oil pool 24, and the other end of the coolant flow channel 26 communicates with the coolant flow channel 30.

Accordingly, in the rotating electrical machine 10, the coolant flow channel 26, the coolant flow channel 30, and the coolant flow channel 28 exist in this order from the oil pool 24, as coolant flow channels. Oil in the oil pool 24 flows in the order of the oil pool 24→the coolant flow channel 26→the coolant flow channel 30→the coolant flow channel 28 under the effect of a rotating centrifugal force.

In this embodiment of the invention, the coolant flow channel 28 functions as a first coolant flow channel that supplies coolant into the rotor core, and the coolant flow channel 30 functions as a second coolant flow channel that introduces coolant in the rotor shaft 22 into the coolant flow channel 28.

Oil that has flowed through the respective coolant flow channels of the rotor 16 to cool the rotor 16 further cools the stator 14, and is accumulated in the in-case oil pool portion 40. Oil that has been accumulated in the in-case oil pool portion 40 is pumped up by the oil pump 42, and is supplied in a circulating manner again to the oil pool 24 of the rotor shaft 22. Incidentally, oil is supplied in a circulating manner after being cooled by an oil pan or the like, or after being cooled by a known heat exchanger that exchanges heat between outside air or cooling water and oil.

In the rotating electrical machine 10 according to this embodiment of the invention, a coolant discharge hole 32 is further formed in the end plate 20 in the axial direction. One end of the coolant discharge hole 32 communicates with the coolant flow channel (or the in-end-plate oil pool portion) 30, and the other end of the coolant discharge hole 32 extends to an outer face of the end plate 20. A position of communication of the coolant discharge hole 32 with the coolant flow channel 30 is formed in such a manner as to fulfill a predetermined relationship with respect to a position of communication of the coolant flow channel 28 with the coolant flow channel 30. More specifically, with respect to the rotor shaft 22, the position of communication of the coolant discharge hole 32 with the coolant flow channel 30 is formed on a radially inner side (on the rotor shaft 22 side) of the position of communication of the coolant flow channel 28 with the coolant flow channel 30 by a predetermined amount d (d>0). FIG. 1 shows a relationship between both the positions of communication, together with the predetermined amount d. In FIG. 1, the predetermined amount d is defined as a distance between a position of communication between a radially outermost portion of the coolant discharge hole 32 and the coolant flow channel 30, and a position of communication between a radially innermost portion of the coolant flow channel 28 and the coolant flow channel 30.

The coolant discharge hole 32 functions as an adjusting valve that adjusts the amount of oil accumulated in the coolant flow channel 30. That is, the coolant discharge hole 32 is formed on a radially inner side with respect to the position of communication of the coolant flow channel 28 with the coolant flow channel 30. Therefore, in the case where the amount of oil in the coolant flow channel 30 remains constant, oil is not discharged from the coolant discharge hole 32. On the other hand, if the amount of oil in the coolant flow channel 30 exceeds a certain amount and oil reaches the position of communication of the coolant discharge hole 32, oil is discharged from the coolant discharge hole 32 to the outside of the rotor 16. In this sense, the coolant discharge hole 32 can function as an adjusting valve that holds the amount of oil in the coolant flow channel 30 equal to a certain amount. In the case where the rotating centrifugal force is relatively large, oil flows against a conduit resistance of the coolant flow channel 28 in the axial direction. Therefore, the amount of oil accumulated in the coolant flow channel 30 is confined to a certain amount. On the other hand, the rotating centrifugal force is relatively small during low-speed rotation of the rotor shaft 22. Therefore, oil does not flow due to the conduit resistance of the coolant flow channel 28, and the amount of oil accumulated in the coolant flow channel 30 increases. If the coolant flow channel 30 brims with oil, an excessive amount of oil in the oil pool 24 flows into the planetary gear side as described previously. However, if the amount of oil in the coolant flow channel 30 exceeds a certain amount, oil is discharged from the coolant discharge hole 32 to the outside of the rotor 16. Therefore, the occurrence of a situation in which the amount of oil in the oil pool 24 becomes excessive is suppressed.

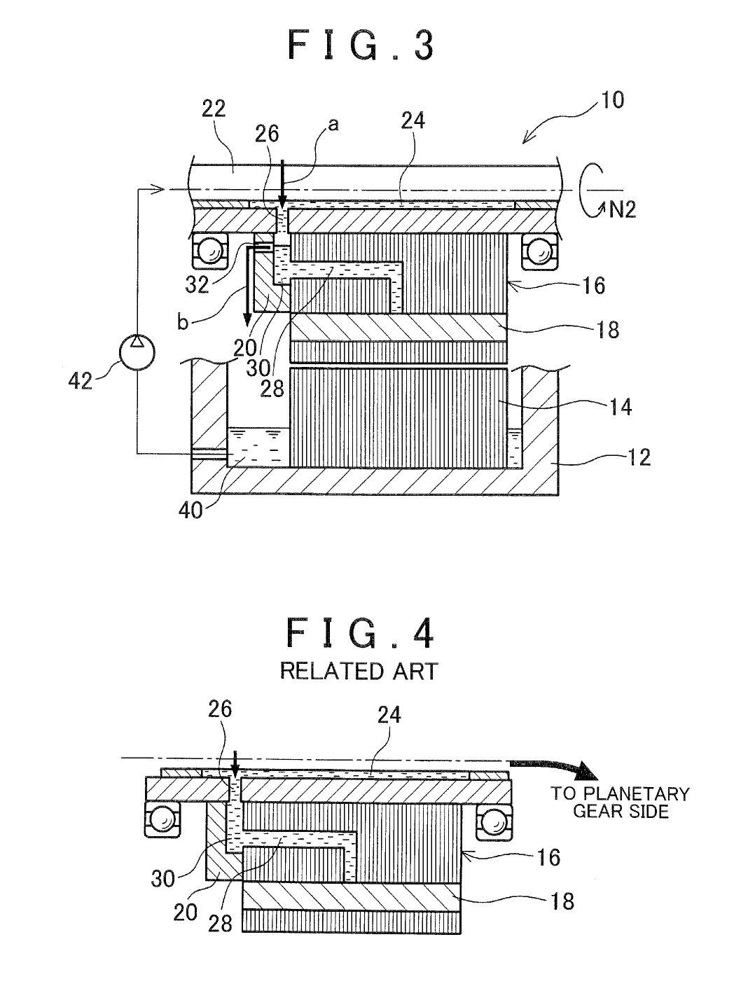

FIGS. 2 and 3 are illustrative views showing the operation according to this embodiment of the invention. FIG. 2 shows the operation during high-speed rotation with a rotational speed N1 of the rotor shaft 22 being equal to or higher than a threshold rotational speed. Oil as coolant is pumped up from the in-case oil pool portion 40 by the oil pump 42, and is supplied to the oil pool 24 of the rotor shaft 22. If the rotor shaft 22 (and the rotor 16) rotates, oil flows from the oil pool 24 into the coolant flow channel 26 due to a rotating centrifugal force. During high-speed rotation, a relatively large rotating centrifugal force indicated by an arrow a in FIG. 2 is applied to the oil pool 24. Oil flows in the order of the oil pool 24→the coolant flow channel 26→the coolant flow channel 30→the coolant flow channel 28 to cool the inside of the rotor 16 and the permanent magnets 18. Oil further cools the stator 14, and is accumulated in the in-case oil pool portion 40. At this time, oil is not discharged from the coolant discharge hole 32, or even if it is, only a small amount thereof is discharged from the coolant discharge hole 32.

FIG. 3 shows the operation during low-speed rotation with a rotational speed N2 of the rotor shaft 22 being lower than the threshold rotational speed. Only a relatively small rotating centrifugal force indicated by an arrow a in FIG. 3 is applied to the oil pool 24. As a result, oil is accumulated, and the amount of oil in the coolant flow channel 30 increases. If the amount of oil in the coolant flow channel 30 increases and oil reaches the coolant discharge hole 32, oil is discharged from the coolant discharge hole 32 to the outside of the rotor 16 as indicated by an arrow b in FIG. 3. That is, oil flows not only in the order of the oil pool 24→the coolant flow channel 26→the coolant flow channel 30→the coolant flow channel 28 but also in the order of the oil pool→the coolant flow channel 26→the coolant flow channel 30→22 the coolant discharge hole 32 to cool the inside of the rotor 16 and the permanent magnets 18. Moreover, since oil can be supplied from the oil pool 24 to the coolant flow channel 26, the amount of oil flowing into the planetary gear side does not become excessively large.

Incidentally, oil that has been discharged from the coolant discharge hole 32 to the outside of the rotor 16 flows through a coil end to be accumulated in the in-case oil pool portion 40. Therefore, an additional effect of making it possible to cool a coil end portion as well is achieved.

According to this embodiment of the invention, not only during high-speed rotation with the rotational speed of the rotor shaft 22 being equal to or higher than the threshold rotational speed but also during low-speed rotation with the rotational speed of the rotor shaft 22 being lower than the threshold rotational speed, a surplus of oil is discharged from the coolant discharge hole 32. As a result, the amount of oil in the rotor shaft 22 is restrained from becoming excessive, and an increase in dragging loss is suppressed. Furthermore, the coil end is cooled by oil discharged from the coolant discharge hole 32, so that a drop in cooling efficiency is suppressed.

[symbol] Modification Examples [symbol] Although the embodiment of the invention has been described above, the invention is not limited thereto, but can be modified in various manners. The invention encompasses all these modification examples.

In this embodiment of the invention, the position of communication of the coolant discharge hole 32 with the coolant flow channel 30 is located on the radially inner side with respect to the position of communication of the coolant flow channel 28 with the coolant flow channel 30. However, the distance d (d>0) between both the positions can be arbitrarily adjusted in accordance with a permissible amount of coolant storable in the coolant flow channel 30 or in accordance with the threshold rotational speed, and can be set in an adaptive manner. That is, the distance d can be set to a value that increases as the permissible amount of coolant storable in the coolant flow channel 30 increases. The distance d can be set to a value that increases as the threshold rotational speed increases.

The coolant flow channels 30 according to this embodiment of the invention can be radially formed while being shifted in phase from one another by 90° around the axis of rotation, in the radial direction of the rotor. On the other hand, the coolant discharge holes 32 may be formed through all of this plurality of the coolant flow channels 30, or the coolant discharge hole 32 or the coolant discharge holes 32 may be formed through an arbitrarily selected one or more of the coolant flow channels 30. For example, the coolant discharge holes 32 are formed only through the coolant flow channels 30 that are shifted in phase from one another by 180°, etc.

The plurality of the coolant discharge holes 32 can also be formed through the single coolant flow channel 30. Instead of making all the distances d of the plurality of the coolant discharge holes 32 equal to one another, it is also possible to make the distances d different from one another. For example, in FIG. 1, the plurality of the coolant discharge holes 32 are formed in the radial direction of the coolant flow channel 30, and the respective distances d are set to d1, d2, d3 . . . etc. It should be noted, however, that d1, d2, d3, . . . >0.

The flow channel shape of the coolant discharge holes 32 is not absolutely required to be tubular, but an arbitrary cross-sectional shape such as a circle, an ellipse, a rectangle or the like can be adopted. The flow channels of the coolant discharge holes 32 are not absolutely required to be rectilinear either, and may be flexed or circular.

The coolant discharge holes 32 according to this embodiment of the invention are formed substantially parallel to one another in the axial direction of the rotor shaft 22. However, instead of being substantially parallel to one another, the coolant discharge holes 32 may be inclined from the positions of communication with the coolant flow channels 30 toward an outer surface of the end plate 20 (inclined from the radially inner side toward the radially outer side).

In this embodiment of the invention, a surplus of oil discharged from the coolant discharge holes 32 flows through the end of the rotor, thereby making it possible to cool the rotor 16. On the other hand, if discharged oil flows into the air gap 15 between the rotor 16 and the stator 14, a dragging resistance results from the viscosity of oil, and a possibility of a dragging loss being caused is also assumed. Therefore, a mechanism that prevents oil from flowing into the air gap 15 may be added.

In this embodiment of the invention, with a view to preventing oil from being discharged from the coolant discharge holes 32 in the case where the rotational speed of the rotor shaft 22 is equal to or higher than the threshold rotational speed, the coolant discharge holes 32 may be provided with on-off valves respectively. It is appropriate to monitor the rotational speed of the rotor shaft 22 by a controller, and control the on-off valves by the controller in such a manner as to perform opening control if the rotational speed of the rotor shaft 22 is lower than the threshold rotational speed, and to perform closing control if the rotational speed of the rotor shaft 22 is equal to or higher than the threshold rotational speed. The opening/closing degree of the on-off valves may be changed in two stages between 0% and 100%, or may be changed stepwise in three or more stages. More specifically, in accordance with a relationship in magnitude between the rotational speed of the rotor shaft 22 and the threshold rotational speed, the opening/closing degree is set to 0% (fully closed) if the rotational speed N is equal to or higher than a threshold rotational speed Nth1, to 50% (half open) if the rotational speed N is lower than the threshold rotational speed Nth1 and equal to or higher than a threshold rotational speed Nth2, and to 100% (fully open) if the rotational speed N is lower than the threshold rotational speed Nth2, etc. It should be noted herein that the threshold rotational speeds Nth1 and Nth2 are defined as values satisfying Nth1>Nth2.

What is claimed is:

1. A rotating electrical machine comprising:
a rotor equipped with a first coolant flow channel therein;
an end plate arranged at an end of the rotor in an axial direction of the rotating electrical machine, the end plate being equipped with a second coolant flow channel that communicates with the first coolant flow channel and a coolant discharge hole, the coolant discharge hole being provided on a radially inner side with respect to a position of communication with the first coolant flow channel, the coolant discharge hole being configured to discharge a certain amount or more of coolant to an outside of the rotor; and
a rotor shaft equipped with a third coolant flow channel that communicates with the second coolant flow channel.

2. The rotating electrical machine according to claim 1, wherein
the coolant discharge hole does not discharge coolant in the second coolant flow channel when a rotational speed of the rotor shaft is equal to or higher than a threshold rotational speed, and the coolant discharge hole discharges a certain amount or more of coolant in the second coolant flow channel when the rotational speed of the rotor shaft is lower than the threshold rotational speed.
